(19) United States
(12) Patent Application Publication
(10) Pub. No.: US 2020/0303741 A1
(43) Pub. Date: Sep. 24, 2020

(54) ISOTROPIC SELF-ASSEMBLY OF GRAPHITE PARTICLES FOR LI-ION ANODE

(71) Applicants: Chongqing Jinkang New Energy Automobile Co., Ltd., Chongqing (CN); SF Motors Inc, Santa Clara, CA (US)

(72) Inventors: Brennan Campbell, Santa Clara, CA (US); Scott Monismith, Santa Clara, CA (US); Yifan Tang, Santa Clara, CA (US); Ying Liu, Santa Clara, CA (US)

(21) Appl. No.: 16/358,682

(22) Filed: Mar. 19, 2019

(51) Int. Cl. H01M 4/62; H01M 4/587; H01M 4/66; H01M 4/133; H01M 4/1393; H01M 10/0525; H01M 10/058

(52) U.S. Cl. CPC H01M 4/621; H01M 4/587; H01M 4/661; H01M 2004/027; H01M 4/1393; H01M 10/0525; H01M 10/058; H01M 4/133

(57) ABSTRACT

The embodiments described herein generally relate to improving conductive pathways within a battery cell. In prior battery cells, a high degree of tortuosity may exist due to complex conductive pathways within the battery cell. Embodiments described herein describe a solution that may orient particles within an electrode so that the particles are aligned in a universal direction. The aligned particles may allow for a relatively vertical conductive pathway within a battery cell, which may decrease tortuosity within the battery cell.

### BACKGROUND OF THE INVENTION

Electric vehicles (EVs) are increasingly being utilized to replace traditional gas engine vehicles. EVs have several advantages over traditional gas engine vehicles, such as, but not limited to, not requiring as much maintenance, being environmentally friendly, and increased performance. However, unlike traditional gas engine vehicles that rely on gas for power, EVs rely on a plurality of battery cells for power. A current disadvantage of utilizing battery cells as a power source is the time it takes to charge the battery cells in comparison to the time it takes to refill a tank of gas. Thus, there is a need to improve charging rates in battery cells within EVs.

### BRIEF SUMMARY OF THE INVENTION

Embodiments described herein generally relate to improving conductive pathways within a battery cell. By improving conductive pathways within a battery cell, various advantages may be recognized such as fast charging of the battery cell. A solution to improving conductive pathways may include a battery cell comprising of an anode. The anode may further comprise of a current collector and an anode slurry in contact with the current collector. The anode slurry may comprise a first set of bonding materials. The battery cell may further include a plurality of materials from a first functional group. In one embodiment, the materials in the first functional group are configured to bond to the first set of bonding materials to orient particles within the anode into a vertical direction. The battery cell may further comprise a cathode and a separator placed between the cathode and anode.

In one embodiment, the first functional group may bond to a perimeter of the current collector in part due to the material make-up of the current collection. In such an embodiment, one or more materials within the current collector may have a strong bonding affinity the first functional group. In one embodiment, the first functional group is part of a self-assembled monolayer. In such an embodiment, the bonding materials may also be part of the self-assembled monolayer, such that the strong bonding affinity between the bonding materials and the first functional group may cause one or more particles within the anode to self-assemble in a particular direction. In one embodiment, the self-assembled monolayer may include alkanethiols. In such an embodiment, the first functional group may comprise alkanethiols. In one embodiment, the self-assembled monolayer may comprise one or more thiols comprising of sulfur. In such an embodiment, the first functional group may comprise one or more thiols comprising of sulfur. In one embodiment, the bonding materials may include gold (Au) particles.

In one embodiment, the anode may comprise one or more carbon particles. The one or more carbon particles may be oriented in the vertical direction between the separator and the current collector at least due to the self-assembled monolayer that may be formed between the carbon particles and between the carbon particles and the current collector. In one embodiment, due in part to the particles within the anode being oriented in the vertical direction, lithium ions may flow from the cathode to the anode in between one or more carbon particles that are oriented in the vertical direction in a vertical conduction pathway. The vertical conduction pathway may result in little to no tortuosity within the battery cell.

### BRIEF DESCRIPTION OF THE DRAWINGS

FIG. 1 depicts a battery cell in accordance with one or more embodiments.

FIG. 2 depicts carbon particles within an anode in accordance with prior systems.

FIG. 3 illustrates a battery cell manufacturing process in accordance with one or more embodiments.

FIG. 4 illustrates self-aligned carbon particles within an anode in accordance with one or more embodiments.

Features, embodiments, and advantages of the present disclosure are better understood when the following Detailed Description is read with reference to the accompanying drawings.

### DETAILED DESCRIPTION OF THE INVENTION

The embodiments described herein generally relate to improving conductive pathways within a battery cell. By improving conductive pathways within a battery cell, various advantages may be recognized such as fast charging of the battery cell. A battery cell within an EV may contain graphite-based anodes. However, there are certain limitations with graphite-based anodes. For example, graphite-based anodes may contain relatively high tortuosity because “flake” or “platelet-like” graphite particles are utilized in the anode. Tortuosity may be a measure of a deviation of an ionic pathway from a straight line. Stated another way, when ions travel from a cathode of a battery cell to an anode of the battery cell, during a charging process, the ionic pathway taken by one or more of the ions may include many curves and turns. This tortuosity may result in a longer charge time for the battery cell, as it takes the ions longer to reach the current collector within the anode of the battery cell.

Another technical problem with graphite-based anodes is that, by nature, graphite has effective ion diffusivity in the in-plane direction with respect to its crystal structure. As a result, it may be extremely thermodynamically unfavorable for ions to diffuse in the through-plane direction through graphite particles. Instead of diffusing in the through-plane direction, diffusion takes place in the in-plane direction. Such a diffusion requires ions to travel around the graphite particles to find an edge site to begin a redox reaction and subsequent diffusion. Traveling along the perimeter of graphite particles may increase tortuosity within a battery cell due to the path the ion must take.

To remedy the technical issues with graphite-based anodes, embodiments described herein describe a solution that orients the graphite particles of an anode (i.e., negative electrode) so that the two dimension (2D) planes within the graphite particles are oriented vertically. In one embodiment, oriented vertically may mean vertical with respect to a current collector (of an anode) and a separator. By orienting the graphite particles in a vertical direction, ions may have a direct pathway to access edge sites of the graphite crystal planes, which results in the ions having a shorter diffusion pathway. The vertical orientation may also lead to reduction in tortuosity within a battery cell because now an ionic pathway for an ion may be vertical or relatively vertical with little to no turns or curves. Short diffusion pathways and a reduction in tortuosity may increase the performance of a battery cell. For example, faster charging may be achieved with a short diffusion pathway and a reduction in tortuosity because ions may travel to the negative electrode faster than in a battery cell without the short diffusion pathway and the reduction in tortuosity.

In one embodiment, graphite particles within an anode may be vertically oriented by utilizing organic linkers which may self-assemble on the surface of the graphite particles and/or on the current collector. The organic linkers may be self-assembling monolayers, or any other type of organic polymer that may self-assemble. The organic linkers may bind selectively to the edge-sites of the graphite particles. In one embodiments, the organic linkers may bind to the edge-sites of the graphite particles, because the edge-sites may have a reduced energy barrier which may attract the organic linkers to the edge-sites. Once, the organic linkers are attached to the edge-site of a plurality of graphite particles it may cause the graphite particles to automatically orient in a vertical direction. As a result, the organic linkers may self-assemble the graphite particles in a vertical orientation such that organic linkers at the edge-sites of the graphite particles are connected to each other. In one embodiment, the organic linkers may be connected to one or more bonding particles within or attached to the graphite particles. Adding the organic linkers and/or the bonding particles to the graphite particles or the current collector may be referred to as functionalizing the graphite particles or functionalizing the current collector, respectively. In one embodiment, functionalizing the current collector may not include introducing bonding particles to the current collect because the current collector may already be comprised of elements or particles that may bond to the organic linkers. For example, the current collector may be comprised of copper and copper may naturally bind to one or more organic linkers utilized.

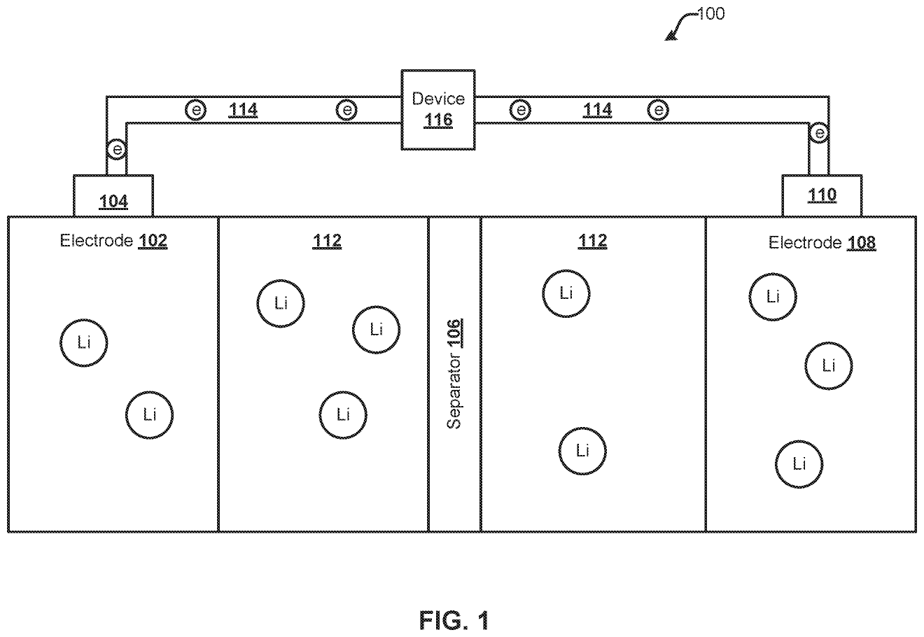

FIG. 1 depicts example battery cell 100 that may be implemented by one or more embodiments. Cell 100 may be a cell within a Lithium Ion (Li-ion) battery. Cell 100 produces electrical energy from chemical reactions. Cell 100 may be repeatedly charged and discharged. Cell 100 may comprise electrode 102, terminal 104, separator 106, electrode 108, terminal 110, electrolyte 112 and electron path 114.

Electrode 102 may be a positive electrode (e.g., a cathode) comprised of different material types. For example, electrode 102 may be comprised of lithium-cobalt oxide (LiCoO₂), lithium iron phosphate (LiFePO₄), and/or another metal based alloy. Electrode 102 may, prior to the initiation of a charging process, contain a plurality of lithium ions. During the charging process, the lithium ions (e.g., positively charged lithium ions) within electrode 102 may flow, via electrolyte 112, through separator 106 to electrode 108. During a discharging process the opposite may take place and the lithium ions within electrode 108 may flow, via electrolyte 112, though separator 106 and back to electrode 102. Although electrolyte 112 is shown as a separate component within battery cell 100, in many instances, electrodes 102 and 108 may be soaked in electrolyte 112 such that lithium ions may flow between electrode 102 and electrode 108 via separator 106.

Terminal 104 may be a current collector attached to electrode 102. Terminal 104 may be a positive current collector. Terminal 104 may be comprised of various materials including, but not limited to, copper, nickel, and/or compounds including copper and/or nickel. During a charging process, lithium ions within electrode 102 may flow from electrode 102 and electrons may be released. These electrons may flow from electrode 102 to terminal 104 and then from terminal 104, via electron path 114, to terminal 110. Because current flows in the opposite direction of electrons, terminal 104 may collect current during the charging process. Separator 106 may separate electrode 102 and electrode 108 while allowing lithium ions to flow between electrode 102 and electrode 108. Separator 106 may be a microporous isolator with little to no electrical conductivity. Separator 106 may also prevent the flow of electrons within electrolyte 112. By preventing electrons from flowing within electrolyte 112, separator 106 may force electrons to flow via electron path 114. Separator 106 may be comprised of various microporous materials, including, but not limited to, polyolefin, polyethylene, polypropylene, and similar compounds.

Electrode 108 may be a negative electrode (e.g., an anode) comprised of different material types. For example, electrode 108 may be comprised of carbon (e.g., graphite), cobalt, nickel, manganese, aluminum, and/or compounds including carbon, cobalt, nickel, manganese, and/or aluminum. Electrode 108 may, prior to the initiation of a charging process, contain none of or a small amount of lithium ions. During the charging process, the lithium ions (e.g., positively charged lithium ions) within electrode 102 may flow, via electrolyte 112, through separator 106 and to electrode 108. During a discharging process, the opposite may take place and the lithium ions within electrode 108 may flow, via electrolyte 112, though separator 106 and to electrode 102.

Terminal 110 may be a current collector attached to electrode 108. Terminal 110 may be a negative current collector. Terminal 110 may be comprised of various materials including, but not limited to, aluminum and/or aluminum based compounds. During a charging process, electrons may flow to or from electrode 102 to terminal 104 and then from terminal 104, via electron path 114, to terminal 110. Because current flows in the opposite direction of electrons, terminal 110 may collect current during a discharging process (e.g., when lithium ions flow from electrode 108 to electrode 102).

Electrolyte 112 may be a solution of solvents, salts, and/or additivities that act as a transport medium for lithium ions. Lithium ions may flow between electrodes 102 and 108 via electrolyte 112. In one embodiment, when an external voltage is applied to one of or both of electrodes 102 and 108, the ions in electrolyte 112 are attracted to an electrode with the opposite charge. For example, when external voltage is applied to cell 100, the lithium ions may flow from electrode 102 to electrode 108. The flow of ions within electrolyte 112 is due to the fact that electrolyte 112 has a high ionic conductivity due to the material make up of electrolyte 112. Electrolyte 112 may be comprised of various materials such as ethylene carbonate (EC), dimethyl carbonate (DMC), and/or lithium salts (e.g., LiClO₄, LiPF₆, and the like). In a solid state version of cell 100, electrolyte 112 may be a solid and may act as the separator. In such an embodiment the solid electrolyte may act as the separator between the electrode 102 and electrode 108, replacing separator 106.

Electron path 114 may be a path through which electrons flow between electrode 102 and electrode 108. Separator 106 may allow the flow of lithium ions between electrode 102 and electrode 108 via electrolyte 112, but separator 106 may also prevent the flow of electrons between electrode 102 and electrode 108 via electrolyte 112. Because the electrons cannot flow via electrolyte 112, they instead flow between electrode 102 and electrode 108 via electron path 114. In one embodiment, device 116 may be attached to electron path 114 and during a discharging process the electrons flowing through electron path 114 (from electrode 108 to electrode 102) may power device 116. In one embodiment, device 116 may only be attached to electron path 114 during a discharge process. In such an embodiment, during a charging process when an external voltage is applied to cell 100, device 116 may be directly powered or partially powered by the external voltage source.

Device 116 may be a parasitic load attached to cell 100. Device 116 may operate based at least in part off of current produced by cell 100. Device 116 may be various devices such as an electronic motor, a laptop, a computing device, a processor, and/or one or more electronic devices. Device 116 may not be a part of cell 100, but instead relies on cell 100 for electrical power. For example, device 116 may be an electronic motor that receives electric energy from cell 100 via electron path 114 and device 116 may convert the electric energy into mechanical energy to perform one or more functions such as acceleration in an EV. During a charging process, when an external power source is connected to cell 100, device 116 may be powered by the external power source (e.g., external to cell 100). During a discharging process, when an external power source is not connected to cell 100, device 116 may be powered by cell 100.

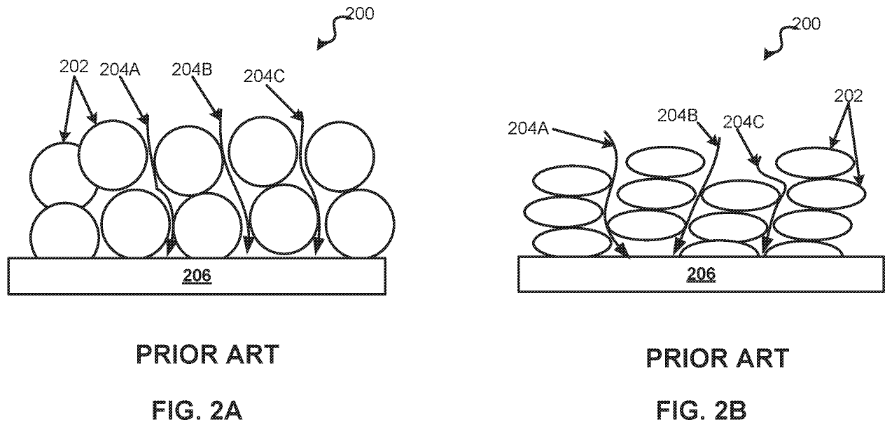

FIGS. 2A and 2B illustrate graphite particles within an anode in accordance to prior systems. FIG. 2A may represent graphite particles within anode 200 prior to a calendaring process and FIG. 2B may represent the same graphite particles within anode 200 after the calendaring process. FIG. 2A comprises anode 200 and anode 200 comprises a plurality of graphite particles 202, ion pathways 204A-204C, and current collector 206. Lithium ions may travel via one or more ion pathways 204A-204C between the plurality of graphite particles 202 towards current collector 206. In traditional graphite-based anodes, graphite particles 202 may be “flake” or “platelet-like” and may be arranged in a structure that resembles a brick-and-mortar like assembly. Because ions flow along the edges of graphite particles 202, their brick-and-mortar like assembly may cause ion pathways 204A-204C to have a high tortuosity. During, for example a charging process, lithium ions may move along ion pathways 204A-204C toward current collector 206 and intercalate between sheets of graphite particles 202. Thus the longer ion pathways 204A-204C are, the longer it may take lithium ions to intercalate between sheets of graphite particles 202. The amount of lithium ions that intercalate between sheets of graphite particles 202 may determine the state of charge or the remaining battery life of a battery cell.

In one embodiment, anode 200 of FIG. 2A represents anode 200 prior to a calendaring process. Calendaring may be a process through which anode 200 and one or more of its components (e.g., every component except current collector 206) are compacted to improve the volumetric energy density and rate performance of anode 200. However, calendaring may also increase the distance of ion pathways 204A-204C as shown in FIG. 2B. FIG. 2B depicts anode 200 after calendaring. The calendaring process may exacerbate the brick-and-mortar like assembly of anode 200, causing increased tortuosity of ion pathways 204A-204C. Thus, while calendaring has certain benefits it may also have unintended disadvantages with graphite-based anodes according to prior systems.

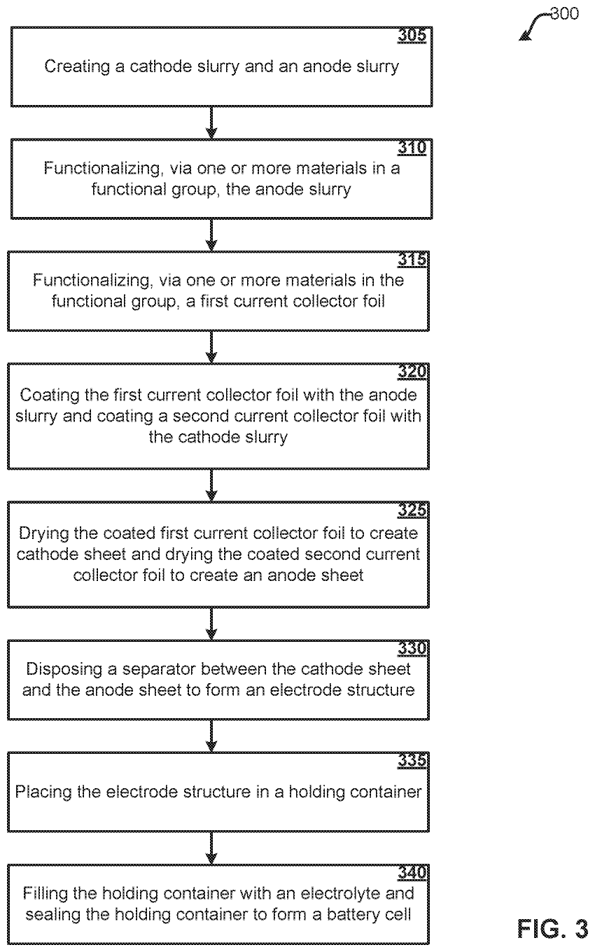

To remedy the issues with graphite-based anodes according to prior systems, a new anode structure may be manufactured that comprises graphite (or other particle types) particles that are aligned in a vertical orientation instead of in a brick-and-mortar like structure. FIG. 3 illustrates process 300 for manufacturing a battery cell according to one or more embodiments. Process 300 may involve one or more manufacturing devices such as a slurry machine, foil coating machine, drying machine, one or more large reels and the like. At 305, a cathode slurry and an anode slurry are created. In one embodiment, the materials that make up a cathode and/or an anode may be received (e.g., at a manufacturing facility) in the form of a powder. For example, a cathode powder may be a powder form of LiCoO₂ or LiFePO₄. In another example, an anode powder may be a powder form of carbon (graphite). In one embodiment, the structural make up of an electrode powder may alter the electrical or chemical characteristics of the electrode. For example, electrode powders that contain particles with smooth spherical shapes and rounded edges may be ideal as electrode powders that contain particles with sharp or flakey surfaces may be susceptible to higher electrical stress and decomposition. Electrical stress and decomposition may lead to possible thermal runway when the electrode is in use within a cell. The cathode powder may be mixed with a conductive binder to form a cathode slurry. The anode powder may be mixed with a conductive binder to form an anode slurry.

At 310, the anode powder is functionalized, via one or more materials in a functional group, the anode slurry. Functionalizing may be defined as engineering an object (e.g., graphite particles, surface of a current collector, and the like) to interact with other objects. Functionalizing may be achieved by the inclusion of materials in functional groups. Functional groups may be specific moieties within molecules that are responsible for the characteristic chemical reactions of those molecules. Thus by using materials from a function group a predictable chemical reaction may be realized. In one embodiment, the anode power may be functionalized by the inclusion of one or more organic linkers such as self-assembling monolayers to the anode powder. In on embodiment, a self-assembly monolayer may include alkanethiols, copper, gold, and/or thiols comprising carbon-sulfur-hydrogen. In one embodiment, the anode powder may decorated with gold particles (or another suitable element). These gold particles may have a strong affinity and bond strength with thiols (carbon-sulfur-hydrogen). Thus, when the thiols are introduced either at 310 or a later point (e.g., 320, 325) they may bond to the gold particles that are decorated within the graphite particles within the anode powder creating a self-assembling monolayer. In one embodiment, the organic linkers may not have magnetic properties, as compounds with magnetic properties may noticeably increase the weight of the anode slurry, which may ultimately increase the weight to the resultant battery cell.

At 315, a first current collector foil is functionalized via one or more materials in a functional group. The first current foil may be a foil that is specific to the anode slurry. For example, the first current collector foil may be a copper foil, nickel foil, or the like. The surface of the first current collector foil may be functionalized by one or more materials from a function group. The function group may be the same as the functional group that functionalizes the anode slurry or it may be a function group that reacts with the function group that functionalizes the anode slurry. In either instance, the functionalized surface of the first current collector and the functionalized anode slurry may contain organic linkers that interact with each other such that the carbon particles within the anode slurry self-assemble, at some later point, in a vertical orientation. The self-assembly may occur after the coating process (320) or the drying process (325). In one embodiment, the first current collector foil may be functionalized via the inclusion of copper. In such an embodiment, thiols comprising carbon-sulfur-hydrogen may be capable of bonding to copper. Due in part to its ability to bond with copper and other elements such as gold, these thiols may be utilized to self-assemble graphite particles within an anode slurry to the first current collector foil in a vertical orientation.

At 320, the anode slurry is coated onto the first current collector foil and the cathode slurry is coated onto a second current collector foil. The first current collector foil may be a foil that is specific to the anode slurry. For example, the first current collector foil may be a copper foil, nickel foil, or the like. The second current collector foil may be a foil that is specific to a cathode slurry. For example, the second current collector foil may be an aluminum foil and the like. Each current collector foil may be delivered by large reels and may be fed into separate coating machines. While in separate coating machines, each current collector foil has a corresponding slurry that is spread on its surface. For example, the first current collector foil may be fed, by a large reel, into an anode coating machine. While in the anode coating machine, the anode slurry produced at 310 may be spread on the surface of the first current collector foil as the first current collector foil passes through the anode coating machine. During the coating process, the thickness of a coated current collector foil may be modified such that the coated current collector foil has a desired thickness. In one embodiment, the thickness of the coated current collector foil may alter the energy storage per unit area of an electrode that is formed from that coated current collector foil.

At 325, the coated first current collector foil and the coated second current collector foil are dried. The coated current collector foils may be dried by feeding the coated current collector foils into a drying oven. Inside the drying oven, the respective electrode material (e.g., cathode or anode slurry) may be baked onto the coated current collector foil. Once the electrode material is baked onto a coated current collector foil, the coated current collector foil may be cut (e.g., width wise) into a size desired for a particular application. At the end of 325, an anode sheet may be formed from the processing applied to the first current collector foil and a cathode sheet may be formed from the processing applied to the second current collector foil. In one embodiment, during 325, the organic linkers utilized to functionalize the anode slurry and the first current collector foil may self-assemble carbon particles within the anode slurry in a vertical orientation.

At 330, a separator is disposed between the cathode sheet and the anode sheet forming an electrode structure. The separator may be a microporous insulator. In one embodiment, a separator may be disposed between the cathode sheet and anode sheet in a prismatic cell structure. In a prismatic cell structure, the cathode and anode sheets are cut into individual electrode plates and the separator is placed in the middle of the electrode plates. In one embodiment, the separator may be applied as a single long strip in a zig zag fashion. In such an embodiment, the separator would be woven in between alternate electrodes in the stack. For example, a first layer in the prismatic cell may be a first cathode sheet, the second layer may be a separator, the third layer may be a first anode sheet, the fourth layer may be the separator, the fifth layer may be a second cathode sheet, the sixth layer may be the separator, the seventh layer may be a second anode sheet, and so forth. This stacked configuration may be used for high capacity battery applications to optimize space.

In one embodiment, a separator may be disposed between the cathode sheet and anode sheet in a cylindrical cell structure. In a cylindrical cell structure, the cathode sheet, the separator, and the anode sheet are wound onto a cylindrical mandrel in such a way that the cathode sheet and anode sheet are separated by the separator. The result of this winding process is a jelly roll. An advantage of the cylindrical cell structure is that it requires only two electrode strips which simplifies the construction process over other structures (e.g., prismatic cell). A first tab may be included on the cathode sheet and a second tab may be included on the anode sheet. Each respective tab may be a connection point to the respective electrode (e.g., to connect to an external device).

At 335, the electrode structure is placed in a holding container. The holding container may depend upon the cell structure of the electrode structure. For example, a holding container may be a can-shaped container for a cylindrical cell structure. At 340, once the electrode structure is inside the holding container the holding container is filled with an electrolyte and sealed. The filling of the holding container with the electrolyte may be referred to as an electrolyte wetting process. After the holding container is sealed the battery cell is formed. Once the battery cell is formed the battery cell may be charged and discharged once to activate the materials (e.g., cathode, anode, lithium ions, etc.) inside the battery cell to make the battery cell active.

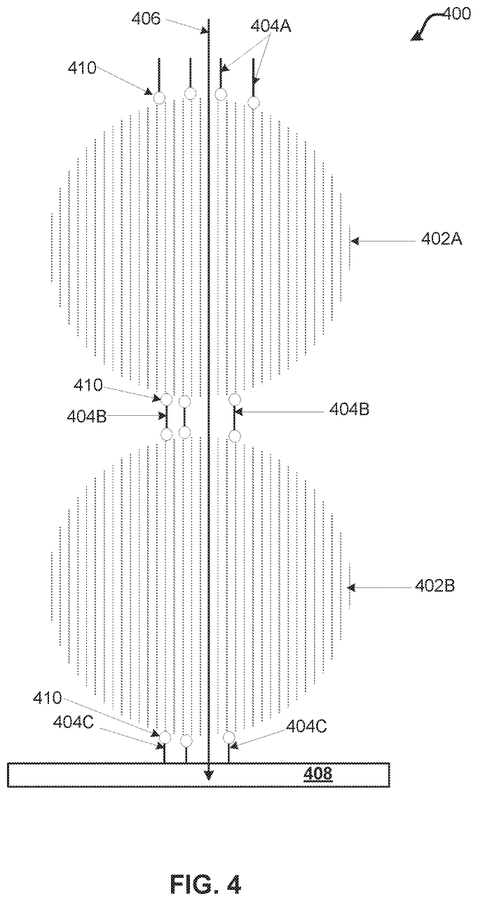

FIG. 4 depicts a simplified vertically aligned carbon particle structure 400 in accordance with one or more embodiments. As a result of functionalizing the anode slurry and/or the surface of the current collector with organic linkers, the carbon particles in the anode slurry self-assemble in a vertical orientation. Carbon particle structure 400 may be part of an anode within a battery cell and includes carbon particles 402A and 402B, organic linker groups 404A-404C, ion pathway 406, current collector 408, and bonding particles 410. Carbon particles 402A and 402B may spherical-shaped carbon particles (or other shape carbon particles). Carbon particles 402A and 402B may be carbon particles within a carbon sheet within an anode of a battery cell. In such an embodiment, the anode may comprise a plurality of carbon sheets and lithium ions (or other ions) may intercalate between the plurality of carbon sheets during, for example, a charging process of the battery cell. Carbon particles 402A and 402B are aligned vertically by organic linker group 404B and bonding particles 410. Organic linker groups 404A-404C may be groups of organic linkers that combine with each other to self-assemble in a vertical fashion. For example, the organic linkers of organic linker group 404B may be attached to carbon particle 402A and carbon particle 402B via bonding particles 410. The organic linkers attached to each of these carbon particles (via one or more bonding particles 410) may interact with each other to connect with each other. The connection of the organic linkers with each other may cause the attached carbon particle to orient in a particular direction (e.g. vertical direction). The organic linkers in organic linker group 404B may bond to the outer edges of carbon particles 402A and 402B due to the presence of bonding particles 410 within (or attached to) carbon particles 402A and 402B. Bonding particles 410 have a strong affinity with the organic linkers of organic linker group 404B. Once the edges of carbon particles 402A and 402B have been functionalized due to the inclusion of bonding particles 410, organic linkers may react with the bonding particles 410 to self-assemble carbon particles 402A and 402B into a vertical orientation.

Organic linker group 404C may be a set of organic linkers that are attached to the surface of current collector 408. Organic linker group 404C may functionalize the surface (e.g., one or more parts of the perimeter) of current collector 408 because the energy barrier on the surface may be less than the energy barrier of internal portions of current collector 408. Similar to organic linker group 404B, organic linker group 404C may self-assemble in a vertical orientation which may cause carbon particle 402B to orient in a vertical direction. Thus, organic linker group 404C and organic linker group 404B may be responsible for carbon particle 402B's vertical orientation. Carbon particle 402B's vertical orientation may serve as a base for carbon particle 402A's vertical orientation, because carbon particle 402B is closest to current collector 408. Organic linker group 404A may be attached to carbon particle 402A and another carbon particle that is not shown. Carbon particles may be vertically oriented from current collector 408 up until a separator.

Bonding particles 410 may be particles made of elements such as gold that have a strong bonding affinity to materials within current collector 408 and/or carbon particles 402A and 402B. In one embodiment, bonding particles 410 may be added to carbon particles 402A and 402B during the manufacturing process of vertically aligned carbon particle structure 400. The bonding particles may assimilate around the edges of carbon particles 402A and 402B. The inclusion of bonding particles 410 may allow organic linkers within organic linker groups 404A, 404B, and 404C to connect with carbon particles 402A and 402B as well as current collector 408. For example, organic linkers within organic linker groups 404A, 404B, and 404C may comprise thiols comprising carbon-sulfur-hydrogen. These thiols may have a strong bonding affinity to, for example, copper within current collector 408, and to bonding particles 410 that are located on or within carbon particles 402A and 402B. This strong bonding affinity may create a self-assembling monolayer comprising the thiols that self-assemble carbon particles 402A and 402B in a vertical orientation as illustrated in FIG. 4. In one embodiment, bonding particles 410 may bond to the perimeter of carbon particles 402A and 402B because the energy barrier around the perimeter of a carbon particle may be less than the energy barrier internal to the carbon particle. By bonding to the perimeter of a carbon particle, bonding particles 410 may attach and connect to organic linkers which may cause carbon particles to self-assemble in an organized and uniform orientation. Similarly because the energy barrier around the perimeter of current collector 408 may be less than the energy barrier internal to current collector 408 organic linkers may attach to the perimeter of current collector 408. In some embodiments, current collector 408 may not include bonding particles 410 when the material make up of current collector 408 has a strong bond with organic linkers that also have a strong bond to bonding particles 410. For example, current collector 408 may comprise of copper and bonding particles 410 which may comprise of gold, both of these materials have a strong bonding affinity to thiols, which may be utilized as an organic linker.

The vertical orientation of carbon particles from current collector 408 to a separator may create ion pathway 406. During, for example, a charging process lithium ions may flow from the cathode through the separator and to the anode comprising carbon particle structure 400. Ion pathway 406 may be a conduction or diffusion pathway for one or more lithium ions. Lithium ions may follow ion pathway 406 in order to intercalate between layers of graphite within the anode. As can be seen from FIG. 4, ion pathway 406 is a vertical pathway within the 2D direction. In comparison with the ion pathways 204A-204C in FIG. 2, ion pathway 406 is straighter which may reduce the ion pathway within an anode as well as reduce the tortuosity within the anode. Thus, according to one or more embodiments presented herein an anode with a vertically aligned particle structure may be recognized which may improve the performance of a battery cell.

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations, and/or additions to the present subject matter as would be readily apparent to one of ordinary skill in the art. Indeed, the methods and systems described herein may be embodied in a variety of other forms; furthermore, various omissions, substitutions and changes in the form of the methods and systems described herein may be made without departing from the spirit of the present disclosure. The accompanying claims and their equivalents are intended to cover such forms or modifications as would fall within the scope and spirit of the present disclosure.

Conditional language used herein, such as, among others, “can,” “could,” “might,” “may,” “e.g.,” and the like, unless specifically stated otherwise, or otherwise understood within the context as used, is generally intended to convey that certain examples include, while other examples do not include, certain features, elements, and/or steps. Thus, such conditional language is not generally intended to imply that features, elements and/or steps are in any way required for one or more examples or that one or more examples necessarily include logic for deciding, with or without author input or prompting, whether these features, elements and/or steps are included or are to be performed in any particular example.

The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Similarly, the use of “based at least in part on” is meant to be open and inclusive, in that a process, step, calculation, or other action “based at least in part on” one or more recited conditions or values may, in practice, be based on additional conditions or values beyond those recited. Headings, lists, and numbering included herein are for ease of explanation only and are not meant to be limiting.

The various features and processes described above may be used independently of one another, or may be combined in various ways. All possible combinations and sub-combinations are intended to fall within the scope of the present disclosure. In addition, certain method or process blocks may be omitted in some embodiments. The methods and processes described herein are also not limited to any particular sequence, and the blocks or states relating thereto can be performed in other sequences that are appropriate. For example, described blocks or states may be performed in any order other than that specifically disclosed, or multiple blocks or states may be combined in a single block or state. The example blocks or states may be performed in serial, in parallel, or in some other manner. Blocks or states may be added to or removed from the disclosed examples. Similarly, the example systems and components described herein may be configured differently than described. For example, elements may be added to, removed from, or rearranged compared to the disclosed examples.

What is claimed is:

1. A battery cell comprising:
an anode comprising:
a current collector;
an anode slurry in contact with the current collector comprising a first set of bonding materials;
a plurality of materials from a first functional group, wherein the materials in the first functional group are configured to bond to the first set of bonding materials to orient particles within the anode into a vertical direction; and
a cathode; and
a separator placed between the cathode and anode.

2. The battery cell of claim 1, wherein the first functional group bonds to a perimeter of the current collector.

3. The battery cell of claim 1, wherein the first functional group is included in a self-assembled monolayer.

4. The battery cell of claim 3, wherein the self-assembled monolayer includes alkanethiols.

5. The battery cell of claim 1, wherein the anode comprises one or more carbon particles and the one or more carbon particles are oriented in a vertical direction between the separator and the current collector.

6. The battery cell of claim 5, wherein lithium ions flow from the cathode to anode in between the one or more carbon particles that are oriented in the vertical direction.

7. The battery cell of claim 5, wherein the oriented one or more carbon particles causes a vertical conduction pathway for ions moving from the cathode to the current collector.

8. The battery cell of claim 3, wherein the self-assembled monolayer includes one or more thiols comprising sulfur.

9. The battery cell of claim 3, wherein the self-assembled monolayer includes one or more gold particles.

10. The battery cell of claim 1, wherein the current collector comprises of copper.

11. A method for manufacturing a battery cell comprising:
receiving an anode slurry comprising a first set of bonding materials;
placing the anode slurry on a current collector to form an anode;
adding to the anode, materials from a first functional group, wherein the materials from the first functional group are configured to bond to the first set of bonding materials to orient particles within the anode into a vertical direction; and
placing a separator between the anode and a cathode to form the battery cell.

12. The method of claim 11, wherein the first functional group bonds to a perimeter of the current collector.

13. The method of claim 11, wherein the first functional group is included in a self-assembled monolayer.

14. The method of claim 13, wherein the self-assembled monolayer includes alkanethiols.

15. The method of claim 11, wherein the anode comprises one or more carbon particles and the one or more carbon particles are oriented and aligned in a vertical direction between the separator and the current collector.

16. The method of claim 15, wherein lithium ions flow from the cathode to anode in between the one or more carbon particles that are oriented and aligned in the vertical direction.

17. The method of claim 15, wherein the oriented and aligned one or more carbon particles cause a vertical conduction pathway for ions moving from the cathode to the current collector.

18. The method of claim 13, wherein the self-assembled monolayer includes one or more thiols comprising sulfur.

19. The method of claim 13, wherein the self-assembled monolayer includes one or more gold particles.

20. The method of claim 11, wherein the current collector comprises of copper.
